(19) United States
(12) Patent Application Publication
(10) Pub. No.: US 2025/0297076 A1
(43) Pub. Date: Sep. 25, 2025

(54) HEAT-INSULATING MATERIAL

(71) Applicant: Sumitomo Riko Company Limited, Aichi (JP)

(72) Inventor: Yutaro Taguchi, Aichi (JP)

(73) Assignee: Sumitomo Riko Company Limited, Aichi (JP)

(21) Appl. No.: 19/230,124

(22) Filed: Jun. 6, 2025

Related U.S. Application Data
(63) Continuation of application No. PCT/JP2024/017908, filed on May 15, 2024.

(30) Foreign Application Priority Data
May 31, 2023 (JP) 2023-089432

(51) Int. Cl. C08J 9/28; C08K 5/00; C08K 7/22

(52) U.S. Cl. CPC C08J 9/28; C08K 5/005; C08K 7/22; C08J 2205/026

(57) ABSTRACT

A heat-insulating material is provided, which includes a porous structure in which a plurality of particles are connected to form skeletons and which has pores between the skeletons, infrared ray shielding particles, and organic hollow particles. In the heat-insulating material, the infrared ray shielding particles have a content of 10 mass % or more and 30 mass % or less when a mass of the heat-insulating material is 100 mass %, and the organic hollow particles have a content of 5 mass % or more and 30 mass % or less when a mass of the heat-insulating material is 100 mass %.

### CROSS-REFERENCE TO RELATED APPLICATION

The present application is a continuation of PCT/JP2024/017908, filed on May 15, 2024, and is related to and claims priority from Japanese patent application no. 2023-089432, filed on May 31, 2023. The entire contents of the aforementioned application are hereby incorporated by reference herein.

### BACKGROUND

### Technical Field

The disclosure relates to a heat-insulating material using a porous structure such as an aerogel.

### Related Art

Various heat-insulating materials have been conventionally used for the purpose of heat flow control in automotive parts, residential building materials, industrial equipment, and the like. Materials with low thermal conductivity such as silica aerogel are known as materials for heat-insulating materials. For example, in battery packs mounted in hybrid vehicles or electric vehicles, heat-insulating materials are placed between adjacent battery cells and the like. This type of heat-insulating material is required to have high heat insulating property especially at high temperatures, so that it can suppress heat transfer and prevent thermal runaway in case a battery cell abnormally generates heat. Further, in a battery pack, a battery module formed by laminating a plurality of battery cells is accommodated in a casing in a state where it is fixed by fastening members from two sides in the laminating direction. Battery cells expand and contract with charging and discharging. Thus, it is desirable that the heat-insulating material placed between battery cells can deform in response to external pressure or expansion and contraction of the battery cells, while maintaining its heat insulating property.

For example, Patent Literature 1 (International Publication No. 2017/038646) describes an aerogel composite containing aerogel components and hollow silica particles as an aerogel composite having heat insulating property and flexibility. Patent Literature 2 (Japanese translation of PCT international application No. 2013-543036) describes a product including nanoporous particles and hollow latex particles, in which the hollow latex particles are directly bonded to each other to form a continuous matrix, and the nanoporous particles are dispersed in the continuous matrix of the hollow latex particles.

According to the aerogel composite described in Patent Literature 1 above, flexibility is improved by adding hollow silica particles to the aerogel component. However, hollow silica particles are made of rigid inorganic material, though they have a hollow structure. Thus, the obtained flexibility is not sufficient. Further, in Patent Literature 1, flexibility is merely imparted to the aerogel for the purpose of improving the handleability of the aerogel. Thus, even if the aerogel composite can be compressed and deformed by, for example, an external pressure, it cannot be said that the aerogel composite has the restorability to return to its original shape after unloading. Furthermore, in Patent Literature 1, heat insulating property at high temperatures is not considered.

On the other hand, the hollow latex particles described in Patent Literature 2 are made of polymer and serve as a binder that bonds nanoporous particles together. As described in Patent Literature 2, the hollow latex particles are directly bonded to each other to form a continuous network structure (matrix), and the nanoporous particles are dispersed in the continuous matrix of hollow latex particles. Thus, in the product described in Patent Literature 2, the continuous hollow latex particles become a transmission path for heat, leading to a decrease in heat insulating property. In addition, when using this product at high temperatures, there is a risk that the matrix may decompose, deteriorate, or disappear, making it unable to maintain its shape. Further, paragraph [0044] of Patent Literature 2 states that “the concentration of additional additives such as infrared attenuators and reflective particles is 5 wt % or less based on the total weight of the product.” Even if infrared ray shielding particles are added as an additional additive, a small amount of 5 mass % or less of the entire product will not be effective in blocking radiant heat, and the heat insulating property at high temperatures will be insufficient.

The disclosure provides a heat-insulating material that uses a porous structure, has high heat insulating property even at high temperatures, and excels in flexibility and restorability against compression.

### SUMMARY

(1) The heat-insulating material of the disclosure is a heat-insulating material that includes a porous structure in which a plurality of particles are connected to form skeletons and which has pores between the skeletons, infrared ray shielding particles, and organic hollow particles, in which the infrared ray shielding particles have a content of 10 mass % or more and 30 mass % or less when a mass of the heat-insulating material is 100 mass %, and the organic hollow particles have a content of 5 mass % or more and 30 mass % or less when a mass of the heat-insulating material is 100 mass %.

According to the porous structure, a high heat insulating effect may be obtained by mainly suppressing conduction and convection among the three forms of heat transfer (conduction, convection, and radiation). Here, radiation is a phenomenon in which heat moves via electromagnetic waves, and the higher the temperature, the greater the radiant energy emitted, Thus, in high-temperature environments, radiation becomes the main factor in heat transfer. Consequently, at high temperatures, it is difficult to obtain the desired heat insulating property with just a porous structure, and it becomes effective to use infrared ray shielding particles that may suppress heat transfer by radiation. However, in the case where a large amount of infrared ray shielding particles is compounded, the infrared ray shielding particles connect with each other to form a transmission path for heat, which may lead to increased heat transfer by conduction and a decrease in heat insulating property. According to the heat-insulating material of the disclosure, by specifying the content of infrared ray shielding particles, both radiation and conduction heat transfer may be suppressed, realizing high heat insulating property not only at room temperature but also at high temperatures of 500° C. or higher.

The heat-insulating material of the disclosure has organic hollow particles in addition to infrared ray shielding particles. Organic hollow particles are particles formed from organic material and having voids inside. The organic hollow particles provide flexibility that may deform against compressive loads and restorability after unloading. The organic hollow particles are placed between porous inorganic particles and porous inorganic particles. In the heat-insulating material of the disclosure, because the content of organic hollow particles is relatively small, the organic hollow particles do not easily connect with each other, and many of the organic hollow particles are discontinuously arranged. Thus, in the heat-insulating material of the disclosure, the porous structure forms a matrix, and the organic hollow particles are scattered between the porous structures. Thus, even though the heat-insulating material of the disclosure contains organic hollow particles, which are organic components, transmission paths for heat are not easily formed. As a result, even at high temperatures, the organic hollow particles do not easily disappear, and high heat insulating property may be maintained.
(2) In the above configuration, the porous structure may have an average particle diameter of 1 μm or more and 1000 μm or less, According to this configuration, in addition to the heat insulating property improvement effect by the porous structure being easily exhibited, the shielding effect of radiant heat by the infrared ray shielding particles is also easily exhibited.
(3) In any of the above configurations, the infrared ray shielding particles may have an average particle diameter of 0.3 μm or more and 22 μm or less. According to this configuration, the shielding effect of radiant heat by the infrared ray shielding particles is easily exhibited. In addition, because the infrared ray shielding particles are filled in the gaps between the porous structures, and the connection between the infrared ray shielding particles and other components is suppressed, making it difficult for transmission paths for heat to form, the heat insulating property is less likely to decrease.
(4) In any of the above configurations, the organic hollow particles may have an average particle diameter of 1 μm or more and 1000 μm or less. According to this configuration, both the desired heat insulating property and flexibility and restorability may be achieved.
(5) In any of the above configurations, the organic hollow particles may have an elastic modulus of 1 MPa or more and 30 MPa or less. According to this configuration, the desired flexibility and restorability may be achieved.
(6) In any of the above configurations, the organic hollow particles may be made of one or more selected from natural rubber, isoprene rubber, butadiene rubber, styrene-butadiene rubber, ethylene-propylene-diene rubber, chloroprene rubber, urethane rubber, silicone rubber, ethylene-vinyl acetate rubber, epichlorohydrin rubber, acrylic rubber, styrene-based thermoplastic elastomer, vinyl chloride-based thermoplastic elastomer, olefin-based thermoplastic elastomer, polyester, polyacrylonitrile crosslinked body, polymethyl methacrylate crosslinked body, and polybutyl methacrylate crosslinked body. According to this configuration, the manufacturing of particles having a hollow structure is easy, and the elastic modulus of the obtained hollow particles may be easily adjusted. This makes it possible to achieve the desired flexibility and restorability.
(7) In any of the above configurations, the infrared ray shielding particles may have at least one of particles of one type and particles of a mixture of two or more types selected from silicon carbide, kaolinite, montmorillonite, titanium oxide, silicon nitride, mica, aluminum oxide (alumina), aluminum nitride, boron carbide, iron oxide, magnesium oxide, tin oxide, zinc oxide, tantalum oxide, manganese ferrite, manganese oxide, nickel oxide, nickel, silver oxide, silver, bismuth oxide, carbon black, graphite, titanium, iron titaniurn oxide, zirconium, zirconia, zirconium silicate, barium titanate, manganese dioxide, chromium oxide, titanium carbide, tungsten carbide, tungsten oxide, niobium oxide, indium tin oxide, and cerium oxide. According to this configuration, because the heat capacity of the infrared ray shielding particles is relatively large, the particles themselves are less likely to warm up. In addition, the heat resistance of the infrared ray shielding particles is also high. Thus, it is advantageous for improving the heat insulating property under high temperature conditions.
(8) In any of the above configurations, the porous structure may include silica aerogel in which a plurality of silica particles are connected to form skeletons. Silica aerogel has a good balance between the size of the skeletons and the size of the pores, exhibiting excellent heat insulating property.
(9) In any of the above configurations, it may further include at least one of a processing aid and an inorganic fiber. The processing aid may be appropriately used according to the manufacturing method from the viewpoint of facilitating the manufacture of the heat-insulating material. For example, when water is used as a solvent for the composition for manufacturing the heat-insulating material, by selecting components having dispersion function or thickening function, the powder such as the porous structure and water may be more easily mixed. When compression molding the powder such as the porous structure, by selecting thermoplastic components, the moldability is improved. Further, having inorganic fibers is effective for improving the mechanical strength of the heat-insulating material and preventing the porous structure from falling off.
(10) In any of the above configurations, the organic hollow particles may exist discontinuously between the porous structure and the porous structure. In this configuration, many of the organic hollow particles, which are organic components, are scattered without being continuous. Thus, the transmission path for heat through the organic hollow particles is less likely to be formed, and high heat insulating property may be maintained.
(11) In any of the above configurations, a binder that binds the porous structure, the infrared ray shielding particles, and the organic hollow particles may not be included. Generally, organic materials are used as binders, and if a binder exists, there is a risk that a transmission path for heat may be formed through the binder. In this configuration, since no binder exists, high heat insulating property may be achieved under high temperature conditions.
(12) In any of the above configurations, the organic hollow particles may include single void-type particles having one void inside. The single void-type particles have only the outermost shell part made of organic material, and the rest consists of voids. Thus, according to this configuration, it is easy to reduce the density of the heat-insulating material and to adjust the flexibility.
(13) In any of the above configurations, the organic hollow particles may include multiple void-type particles having multiple voids inside. In the case of multiple void-type particles, the multiple voids are arranged within the particle body made of organic material. That is, in multiple void-type particles, organic material exists not only in the outermost layer but also inside the particles. Thus, according to this configuration, it is easy to adjust the restorability of the heat-insulating material.

According to the heat-insulating material of this disclosure, high heat insulating property may be achieved not only at room temperature but also at high temperatures of 500° C. or higher. According to the heat-insulating material of this disclosure, flexibility that allows deformation against compressive load and restorability after unloading may be achieved.

### DESCRIPTION OF EMBODIMENTS

The heat-insulating material of this disclosure will be described in detail below. The heat-insulating material of this disclosure is not limited to the following embodiments, and may be implemented in various forms with changes and improvements that may be made by those skilled in the art within the scope that does not depart from the gist of this disclosure.

<Heat-Insulating Material>

The heat-insulating material of this disclosure includes a porous structure, infrared ray shielding particles, and organic hollow particles.

[Porous Structure]

The porous structure has skeletons formed by a plurality of connected particles, with pores between the skeletons. The diameter of the particles (primary particles) forming the skeletons is preferably about 2 to 5 nm, and the size of the pores formed between the skeletons is preferably about 10 to 50 nm. In the case where many of the pores are so-called meso pores with a size of 50 nm or less, since the meso pores are smaller than the mean free path of air, air convection is restricted and heat transfer is inhibited. The shape of the porous structure is not particularly limited and may be spherical, irregularly shaped masses, etc., but a chamfered shape or spherical shape is preferable. In this case, the dispersibility of the porous structure improves, making it easier to prepare a composition for manufacturing the heat-insulating material (hereinafter referred to as “heat-insulating material composition”). Further, it is possible to minimize the gaps between porous structures and increase the filling amount, which suppresses the connection between infrared ray shielding particles and organic hollow particles, thereby enhancing heat insulating property. The porous structure may be used as manufactured, or it may be further pulverized before use. For pulverization, grinding device such as jet mills or spheroidizing treatment device may be used. Through pulverization, the corners of the particles are removed, and the particles become rounded in shape. This makes the surface of the heat-insulating material smooth and less prone to cracking.

The average particle diameter of the porous structure is preferably 1 μm or more and 1000 μm or less. If the average particle diameter of the porous structure is less than 1 μm, the filling property of the porous structure decreases and the gaps between porous structures increase, making it difficult to obtain the effect of enhancing heat insulating property. On the other hand, if the particle diameter of the porous structure exceeds 1000 μm, since the infrared ray shielding particles are filled in the gaps between porous structures, there is a risk that areas without infrared ray shielding particles may become larger. In this case, there is a risk that the frequency of infrared rays emitted from the heat source hitting the infrared ray shielding particles decreases, reducing the shielding effect of radiant heat. For example, the average particle diameter of the porous structure is preferably 8 μm or more, and more preferably 50 μm or more. Further, considering the stability of the heat-insulating material composition and ease of coating, it is preferably 500 μm or less, and more preferably 300 μm or less. The average particle diameter of the porous structure may be the median diameter (D₅₀) obtained from the volume-based particle size distribution measured by laser diffraction/scattering method. It is noted that when using commercial products, catalog values may be adopted.

In the case where the particle diameters of porous structures differ, small-diameter porous structures enter the gaps between large-diameter porous structures. This makes it easier to achieve close packing, allowing for a larger filling amount of porous structures. Further, the small-diameter porous structures may inhibit the connection of infrared ray shielding particles and organic hollow particles. As a result, the effect of enhancing heat insulating property becomes greater. From this viewpoint, it is preferable to use porous structures with a wide particle diameter distribution or to combine two or more types with different average particle diameters. Further, in the manufacturing process of the heat-insulating material, the stirring conditions of the materials may be adjusted so that some of the large-diameter particles are crushed into small-diameter particles.

From the viewpoint of enhancing heat insulating property, the content of the porous structure is preferably 40 mass % or more, and more preferably 50 mass % or more when the total mass of the heat-insulating material is 100 mass %. On the other hand, considering the balance between heat insulating property and flexibility and restorability, as well as suppression of falling off, the content of the porous structure is preferably 75 mass % or less, and more preferably 70 mass % or less when the total mass of the heat-insulating material is 100 mass %.

The porous structure preferably has hydrophobic sites on at least the outer surface among the outer surface and the interior (pore-forming surface). Having hydrophobic sites on the surface may suppress the infiltration of moisture and other substances into the pores, thereby maintaining the porous structure and making it less likely for the heat insulating property to be compromised. For example, by surface treatment with silane coupling agents and the like, functions such as hydrophobicity may be imparted to the surface of the porous structure. Further, a porous structure having hydrophobic sites may be manufactured by adopting specific materials as raw materials for the porous structure, or hydrophobic treatment such as imparting hydrophobic groups may be applied during the manufacturing process of the porous structure.

The type of porous structure is not particularly limited. As primary particles, for example, inorganic particles such as silica, alumina, zirconia, and titania may be mentioned. Among these, porous structures with silica as the primary particles are preferable due to their excellent chemical stability. For example, silica aerogel, in which a plurality of silica particles are connected to form skeletons, is suitable because of the good balance between the size of the skeletons and the size of the pores. Further, aggregated structures in which nanoparticles with particle diameters of less than 1 μm are connected to form skeletons are also suitable. As nanoparticles, those generated from fumed silica, wet silica, and these particles that have been pulverized or dispersed, or those generated from nanoparticle sols such as colloidal silica and colloidal alumina may be mentioned.

The manufacturing method of aerogel is not particularly limited, and may be one in which the drying process is carried out at normal pressure or at supercritical conditions. For example, drying at normal pressure allows for easy and low-cost manufacturing. Depending on the difference in drying methods when manufacturing aerogel, those dried at normal pressure are sometimes called “xerogel” and those dried at supercritical conditions are called “aerogel,” but in this specification, both are collectively referred to as “aerogel”.

### [Infrared Ray Shielding Particle]

The infrared ray shielding particles absorb heat from a heat source and re-emit it from the surface on the heat source side, thereby shielding radiant heat from the heat source and contributing to the improvement of heat insulating property, especially under high-temperature conditions. The content of the infrared ray shielding particles is 10 mass % or more when the total mass of the heat-insulating material is taken as 100 mass %, from the viewpoint of sufficiently exhibiting the suppression effect of heat transfer by radiation. When the content of the infrared ray shielding particles is 15 mass % or more, the shielding effect of radiant heat becomes higher. On the other hand, from the viewpoint of suppressing the connection between infrared ray shielding particles and with other components to make it difficult to form a transmission path for heat, the content of the infrared ray shielding particles is 30 mass % or less, and more preferably 20 mass % or less, when the total mass of the heat-insulating material is taken as 100 mass %.

From the viewpoint of being filled in the gaps between porous structures and suppressing the connection between infrared ray shielding particles and with other components to make it difficult to form a transmission path for heat, it is desirable that the particle diameter of the infrared ray shielding particles is relatively small. However, if the particle diameter is too small, infrared rays become less likely to hit the particles, and furthermore, the scattering of infrared rays becomes insufficient, making it difficult to exhibit the shielding effect of radiant heat. From such viewpoints, the average particle diameter of the infrared ray shielding particles is preferably 0.3 m or more and 22 μm or less. The shape of the infrared ray shielding particles is not particularly limited, such as spherical, flat, etc. For the average particle diameter of the infrared ray shielding particles, as in the case of the porous structure, the median diameter (D₅₀) obtained from the volume-based particle size distribution measured by laser diffraction/scattering method may be adopted, and in the case of using commercially available products, catalog values may be adopted.

As infrared ray shielding particles, there may be mentioned particles of one type or particles of a mixture of two or more types selected from silicon carbide, kaolinite, montmorillonite, titanium oxide, silicon nitride, mica, alumina, aluminum nitride, boron carbide, iron oxide, magnesium oxide, tin oxide, zinc oxide, tantalum oxide, manganese ferrite, manganese oxide, nickel oxide, nickel, silver oxide, silver, bismuth oxide, carbon black, graphite, titanium, iron titanium oxide, zirconium, zirconia, zirconium silicate, barium titanate, manganese dioxide, chromium oxide, titanium carbide, tungsten carbide, tungsten oxide, niobium oxide, indium tin oxide, and cerium oxide. Among them, from the viewpoint of enhancing the shielding effect of radiant heat, it is desirable that the infrared ray shielding particles have high-emissivity particles having an emissivity of 0.6 or more in the infrared wavelength region. As the high-emissivity particles, silicon carbide, kaolinite, silicon nitride, mica, alumina, zirconia, aluminum nitride, zirconium silicate, cerium oxide, boron carbide, manganese oxide, tin oxide, iron oxide, and the like may be mentioned. Further, from the viewpoint of enhancing the shielding effect of radiant heat by scattering incident infrared rays, a fora having particles with a high refractive index in the infrared wavelength region is also effective. For example, high-refractive-index particles having a refractive index of 2.0 or more in the visible light wavelength region are preferable. As the high-refractive-index particles, silicon carbide, titanium oxide, zirconia, silicon nitride, aluminum nitride, zinc oxide, tantalum oxide, tungsten oxide, niobium oxide, cerium oxide, manganese oxide, tin oxide, bismuth oxide, iron oxide, barium titanate, and the like may be mentioned.

For example, silicon carbide, titanium oxide, silicon nitride, mica, alumina, aluminum nitride, boron carbide, iron oxide, magnesium oxide, etc. have a relatively large specific heat, so they have a large heat capacity and the particles themselves do not warm tip easily. In this respect as well, they contribute to improving the heat insulating property of the heat-insulating material. In addition, they also have high heat resistance, so they contribute to improving the heat resistance of the heat-insulating material. In particular, silicon carbide is preferable because there is little increase in thermal conductivity even in a high-temperature atmosphere of about 800° C.

### [Organic Hollow Particle]

The content of the organic hollow particles is 5 mass % or more, more preferably 10 mass % or more, and even more preferably 15 mass % or more, when the total mass of the heat-insulating material is 100 mass %, from the viewpoint of imparting flexibility and restorability to the heat-insulating material. On the other hand, from the viewpoint of increasing the content of components that contribute to heat insulation to enhance heat insulating property, and suppressing the connection between organic hollow particles and other components to make it difficult to form a transmission path for heat, the content of the organic hollow particles is 30 mass % or less, and more preferably 20 mass % or less, when the total mass of the heat-insulating material is 100 mass %.

If the particle diameter of the organic hollow particles is too small, it becomes difficult to obtain the effect of improving flexibility and restorability. Thus, the average particle diameter of the organic hollow particles is preferably 1 μm or more, and more preferably 10 μm or more. On the other hand, if the particle diameter is too large, the infrared ray shielding particles placed together may become separated from each other, which may reduce the heat insulating property at high temperatures. Thus, the average particle diameter of the organic hollow particles is preferably 1000 μm or less, and more preferably 500 μm or less and 200 μm or less. The shape of the organic hollow particles is not particularly limited, and may be spherical, flat, etc. For the average particle diameter of the organic hollow particles, as in the case of the porous structure, the median diameter (D₅₀) obtained from the volume-based particle size distribution measured by laser diffraction/scattering method may be adopted, and in the case of using commercially available products, catalog values may be adopted.

The organic hollow particle is a particle having a void inside, and the void may be one or multiple. The former single void-type particle, also called a balloon structure, includes a shell part formed of an organic material and a single void placed inside. The latter multiple void-type particle includes a particle body formed of an organic material and multiple voids placed therein. The multiple void-type particle is a concept that includes porous particles. As the organic hollow particle, either one of the single void-type particle and the multiple void-type particle may be used, or both may be used in combination. The organic hollow particles may be manufactured, for example, by foaming organic particles or by crushing organic foam.

The organic material is not particularly limited. As preferable materials, for example, cross-linked rubbers such as natural rubber, isoprene rubber, butadiene rubber, styrene-butadiene rubber, ethylene-propylene-diene rubber, chloroprene rubber, urethane rubber, silicone rubber, ethylene-vinyl acetate rubber, epichlorohydrin rubber, acrylic rubber; thermoplastic elastomers such as styrene-based, vinyl chloride-based, olefin-based; resins such as polyester, polyacrylonitrile crosslinked body, polymethyl methacrylate crosslinked body, polybutyl methacrylate crosslinked body may be mentioned. The surface of the organic hollow particles may be surface-treated for purposes such as suppressing dust generation and improving handling, improving flame retardancy, and inorganic particles or the like may be attached. Further, in order to improve flame retardancy, the organic material may contain flame retardants or the like.

From the viewpoint of imparting desired restorability to the heat-insulating material, the elastic modulus of the organic hollow particles is preferably 1 MPa or more, and more preferably 2.5 MPa or more. On the other hand, from the viewpoint of imparting desired flexibility against compression to the heat-insulating material, the elastic modulus of the organic hollow particles is preferably 30 MPa or less, and more preferably 20 MPa or less.

In this specification, for the elastic modulus of the organic hollow particles, a value calculated from the results of the following compression test is adopted. First, the organic hollow particle powder is placed in a cylindrical container made of SUS with a diameter of 11.3 mm. Next, a cylindrical pressing jig made of SUS with a diameter of 11.2 mm is inserted into the cylindrical container, and the organic hollow particle powder is pressed by the self-weight (load of 2 N) of the pressing jig. This operation is repeated, and the initial filling height of the organic hollow particle powder is adjusted to 14 mm, and the pressing jig is placed in the compression test machine while inserted in the cylindrical container. Then, using A&D Co., Ltd.'s Tensilon universal material testing machine “RTF1350”, a compression test is performed in which the upper surface of the filled powder is repeatedly pressed with the pressing jig. The conditions of the compression test are as follows.
Speed of pressing jig: 6 mm/min.
Upper limit of compressive stress: 3 MPa,
Number of pressings: 10 times.

After the compression test, a stress-compression rate curve is created based on the obtained data, with the horizontal axis representing the compression rate and the vertical axis representing the compressive stress. The compression rate on the horizontal axis is a value calculated by the following equation (I).

$$Compression rate ( \% ) = Amount of pressing by the pressing jig ( mm ) / 14 [ initial filling height of the organic hollow particle powder ] ( mm ) \times 100 \qquad ( I )$$

Then, in the stress-compression rate curve of the 10th pressing, the point where the compressive stress is 0 MPa and the point where the compressive stress is 3 MPa are connected by a straight line, and the value obtained by multiplying the slope of the resulting line by 100 is defined as the elastic modulus of the organic hollow particles.

The organic hollow particles are disposed between the porous structures. From the viewpoint of preventing the formation of transmission path for heat by the organic hollow particles, it is desirable that most of the organic hollow particles are arranged discontinuously, in other words, in a scattered form. For example, when a heat-insulating material is manufactured in a sheet form and the thickness direction becomes the direction of heat transfer, the organic hollow particles do not form a matrix and do not continue in the thickness direction, making it less likely to impair the heat insulating property.

### [Other Components]

The heat-insulating material of the disclosure may include other components such as processing aids, inorganic fibers, reinforcing inorganic particles, flame retardants, organic fibers, inorganic hollow particles, organic binders, etc., in addition to the porous structure, infrared ray shielding particles, and organic hollow particles, to the extent that they do not impair the effects achieved by the disclosure. It is noted that if a binder that binds the constituent materials such as the porous structure is present, there is a risk that a transmission path for heat may be formed through the binder. Thus, from the viewpoint of suppressing the formation of transmission path for heat and achieving high heat insulating property at high temperatures, it is desirable that the heat-insulating material has a form without a binder.

### (1) Processing Aid

Porous structures having hydrophobic sites on their surface or inside are not easily compatible with water. Among them, silica aerogel and fumed silica aggregated structures tend to float on water due to their low specific gravity. From the viewpoint of facilitating manufacturing, such as improving the water suspendability of the porous structure and making it easier to disperse the porous structure when preparing a heat-insulating material composition using water as a solvent, it is desirable to incorporate a processing aid according to the manufacturing method of the heat-insulating material. Examples of processing aids include surfactants, thickeners, and suspending agents.

Surfactants include ionic surfactants (cationic surfactants, anionic surfactants, amphoteric surfactants) and non-ionic surfactants. For example, when using an ionic surfactant, it is possible to increase the viscosity of the heat-insulating material composition or stabilize the dispersion of materials such as the porous structure in the heat-insulating material composition, even in relatively small amounts. Examples of ionic surfactants include sodium carboxymethyl cellulose (CMC—Na), polycarboxylic acid amine salts, polycarboxylic acid ammonium salts, polycarboxylic acid sodium salts, and TEMPO-oxidized cellulose nanofibers (CNF—Na). When using a non-ionic surfactant, materials such as the porous structure may be more easily incorporated into the solvent when preparing the heat-insulating material composition. Further, when these materials aggregate or separate in the heat-insulating material composition, they may be more easily re-dispersed, or the solvent may be more easily discharged when drying and molding the heat-insulating material. Examples of non-ionic surfactants include polyethylene oxide (PEO) and polyvinyl alcohol (PVA). Further, it is preferable to use both non-ionic surfactants and ionic surfactants in combination, since the above-mentioned effects of each surfactant may be adjusted as desired. For example, the water retention of PEO is not particularly high. Thus, when preparing the heat-insulating material composition, water does not easily enter the gaps between the porous structures, and voids are less likely to occur when water evaporates during drying. As a result, infrared ray shielding particles and organic hollow particles may be more easily filled into the gaps between the porous structures. Further, small-diameter porous structures may be more easily filled into the gaps between large-diameter porous structures.

When processing aids are present on the surface or in the gaps of materials such as porous structures, there is a risk that transmission path for heat may form through the processing aids. Thus, from the viewpoint of suppressing the formation of transmission path for heat, it is desirable that the content of the processing aid is 10 mass % or less, and more preferably 7 mass % or less, when the total mass of the heat-insulating material is 100 mass %.

### (2) Inorganic Fiber

Inorganic fibers physically entangle around the porous structure, thereby improving the mechanical strength of the heat-insulating material while suppressing the detachment of the porous structure. The type of inorganic fiber is not particularly limited, but considering heat resistance and mechanical strength, glass fibers and ceramic fibers such as alumina fibers are preferable. From the viewpoint of exhibiting a reinforcing effect, the content of inorganic fibers is preferably mass % or more when the total mass of the heat-insulating material is 100 mass %. From the viewpoint of preventing the formation of transmission path for heat, it is preferable to make it 15 mass % or less. Considering both the reinforcing effect and the suppression of formation of transmission path for heat, the length of the inorganic fibers is preferably 16 mm or less.

### (3) Reinforcing Inorganic Particle

From the viewpoint of improving the mechanical strength of the heat-insulating material, reinforcing inorganic particles may be incorporated into the heat-insulating material. The type of reinforcing inorganic particles is not particularly limited, and for example, particles with relatively high hardness and specific surface area such as precipitated silica, gel silica, fused silica, wollastonite, potassium titanate, magnesium silicate, glass flakes, calcium carbonate, barium sulfate, etc, may be used.

### (4) Flame Retardant

By incorporating a flame retardant, flame retardancy may be imparted to the heat-insulating material. Known flame retardants such as halogen-based, phosphorus-based, and metal hydroxide-based types may be used. Considering environmental impact, it is preferable to use phosphorus-based flame retardants. Examples of phosphorus-based flame retardants include ammonium polyphosphate, red phosphorus, and phosphate esters. Among these, those that are insoluble in water or those that are coated with a water-resistant resin are preferred because the flame retardant is less likely to flow out even if it comes into contact with moisture during use. For example, ammonium polyphosphate and resin-coated ammonium polyphosphate are preferred.

### <Manufacturing Method of Heat-Insulating Material>

The heat-insulating material of the disclosure may be manufactured by pressure-forming a material including a porous structure, infrared ray shielding particles, and organic hollow particles. Alternatively, it may be manufactured by applying and drying a liquid (including slurry) heat-insulating material composition to a base material, or by pressure-forming a clay-like heat-insulating material composition.

The thickness of the heat-insulating material may be appropriately determined according to the application. For example, from the viewpoint of heat insulating property, it is preferable to make the thickness of the heat-insulating material 0.1 mm or more, 0.5 mm or more, or even 1 mm or more. If the heat-insulating material is too thick, it not only becomes costly but also makes it difficult to install the heat-insulating material in narrow spaces. Thus, for example, 10 mm or less, 8 mm or less is suitable. Particularly from the viewpoint of making the heat-insulating material thinner and enhancing flexibility, it is preferable to make the thickness of the heat-insulating material 5 mm or less, or even 3 mm or less. The density of the heat-insulating material is preferably 0.4 g/cm³ or less.

### <Usage Form of Heat-Insulating Material>

The heat-insulating material of the disclosure may be used alone, or may be used together with a base material supporting the heat-insulating material, an exterior material accommodating the heat-insulating material, etc. The base material may be placed only on one side in the thickness direction of the heat-insulating material, or may be placed on two sides so as to sandwich the heat-insulating material. Further, the heat-insulating material may be covered with a single base material, using the base material as an exterior material. An adhesive layer may be interposed between the heat-insulating material and the base material. The adhesive layer may include, in addition to adhesive components, flame retardants, etc.

Materials for the base material include fabric, resin, paper, steel sheet, etc. Fibers constituting the fabric include glass fiber, rock wool, ceramic fiber, alumina fiber, silica fiber, carbon fiber, metal fiber, polyimide fiber, aramid fiber, polyphenylene sulfide (PPS) fiber, etc. Known ceramic fibers include refractory ceramic fiber (RCF), polycrystalline alumina fiber (polycrystalline wool: PCW), and alkaline earth silicate (AES) fiber. Among these, AES fiber is safer because it has biodegradability. Resins include polyethylene terephthalate (PET), polyimide, polyamide, PPS, etc. Papers include pulp, composite materials of pulp and magnesium silicate, etc. Steel sheets include GAfLVALUNME steel sheet (registered trademark), galvanized iron sheet, stainless steel (SUS) sheet, iron sheet, titanium sheet, etc. The shape of the base material is not particularly limited, and includes woven fabric, non-woven fabric, film, sheet, etc. The base material may consist of a single layer, or may be a laminate in which the same material or different materials are laminated in two or more layers.

For example, woven fabrics (woven cloth), non-woven fabrics manufactured from inorganic fibers such as glass fibers or metal fibers, such as glass cloth, and fire-resistant heat-insulating paper manufactured as a composite material of pulp and magnesium silicate have relatively small thermal conductivity and high shape retention in high-temperature atmospheres. Further, by adopting a base material with high heat resistance, the heat-insulating material of the disclosure may be applied to applications requiring high heat resistance, thus expanding its applications. Furthermore, by adopting a base material with fire resistance, safety is further improved. A base material with high heat resistance may be manufactured from glass fiber, rock wool, ceramic fiber, polyirnide, PPS, etc., and specifically includes glass fiber non-woven fabric, glass cloth, aluminum glass cloth, AES wool paper, polyimide fiber non-woven fabric, etc.

### EXAMPLES

Next, the disclosure is described more specifically by presenting examples.

### <Manufacturing of Heat-Insulating Material Samples>

Heat-insulating material samples with the compositions shown in Table 1 below were manufactured. For samples of Examples 1 to 3, first, water was weighed in a resin container, a surfactant as a processing aid was added, and stirred at 800 rpm for 60 minutes using an air-driven blade-type stirrer to dissolve the surfactant in water. After stopping the stirring, silicon carbide (SiC) powder as infrared ray shielding particles and organic hollow particle powder were added, and further stirred at 800 rpm for 15 minutes. While continuing to stir, silica aerogel powder as a porous structure was added and completely wetted in the liquid. Then, glass fiber as an inorganic fiber was added and stirred at 800 rpm for 30 minutes. Subsequently, additional stirring was performed at 1000 rpm for 10 minutes to manufacture a clay-like heat-insulating material composition.

For samples of Comparative Examples 1 to 3, heat-insulating material compositions were manufactured in the same manner as the samples of Examples 1 to 3, except that organic hollow particle powder was not included, and instead, an organic binder was included in the sample of Comparative Example 2, and organic solid particle powder was included in the sample of Comparative Example 3.

The details of the materials used are as follows.
Silica aerogel powder: Pulverized product of “Aerogel Particles P200” manufactured by Cabot Corporation, average particle diameter 100 μm.
Silicon carbide powder: “Fuji Random GC #4000” manufactured by Fuji Manufacturing Co., Ltd., average particle diameter 5 pn.
Organic hollow particle powder: Acrylonitrile-based copolymer microballoon, “Matsumoto Microsphere (registered trademark) MFL-HD60CA” manufactured by Matsumoto Yushi-Seiyaku Co., Ltd., average particle diameter 50 to 70 pan, elastic modulus 17 MPa.
Surfactant: Polyethylene oxide “PEO-8” manufactured by Sumitomo Seika Chemicals Co., Ltd., viscosity average molecular weight 1.7 million to 2.2 million.
Glass fiber: “ECS03-615” manufactured by Central Glass Fiber Co., Ltd., length 3 mm, fiber diameter 9 μm.
Organic binder: Silicone emulsion, “Siltech E-2152” manufactured by Siltech Corporation.
Organic solid particle powder: Acrylic rubber powder, “XM-TM-1” manufactured by Matsumoto Yushi-Seiyaku Co., Ltd., average particle diameter 30 in.

Next, a base was prepared by stacking a first spacer plate made of SUS on a glass fiber paper. The first spacer plate had a thickness of 7 mm and had a square-shaped injection hole of 150 mm square formed in the center. The manufactured heat-insulating material composition was filled into the injection hole of the first spacer plate and molded into a plate shape. Subsequently, the first spacer plate was removed, a glass fiber paper was stacked from above, and then a second spacer plate was placed on top to manufacture a laminate consisting of “glass fiber paper/heat-insulating layer composition/glass fiber paper/second spacer plate”. The second spacer plate had a thickness of 6 mm and, similar to the first spacer plate, had a square-shaped injection hole of 150 mm square formed in the center. The heat-insulating layer composition previously formed was placed in the injection hole of the second spacer plate. Separately, a first board material made of aluminum with a thickness of 5 mm and a size of 320 mm square, and a second board material made of aluminum with a thickness of 1 mm and a size of 320 mm square were prepared. On one side of the first board material, a plurality of groove portions were formed. Each of the plurality of groove portions exhibited a linear shape with a width of 2.5 mm, a depth of 3 mm, and a length of 200 mm, and were formed in parallel at 5 mm intervals. The second board material had punching holes with a diameter of 1 mm formed throughout at 2 mm intervals. The second board material was stacked on one side of the first board material, and the laminate was placed on top. Then, the second board material was placed on the laminate, and the first board material was stacked with the side having the groove portions facing the second board material. In this state, pressure drying was carried out by hot pressing at a temperature of 165° C. and a load of approximately 980 kN for 10 minutes. After that, the laminate was cooled to room temperature (20° C.±5° C.), and the first board material, the second board material, the second spacer plate, and the upper and lower glass fiber papers were removed to obtain a plate-shaped heat-insulating material sample with a thickness of 6 mm. The density of the obtained heat-insulating material sample was measured using a water displacement density specific gravity meter “DSG-1” manufactured by Toyo Seiki Seisaku-sho, Ltd.

### <Evaluation Method of Heat Insulating Property>

### (1) Measurement of Thermal Conductivity at Room Temperature

The thermal conductivity of the manufactured heat-insulating material sample at room temperature (20° C.±5° C.) was measured using “Non-steady state thermal conductivity tester Quick Lambda HC-10” manufactured by EKO Instruments Co., Ltd.

### (2) Measurement of Thermal Conductivity at High Temperature

The thermal conductivity of the manufactured heat-insulating material sample at 800° C. was measured using “Quick thermal conductivity meter QTM-700” and “High temperature probe PD-31N” manufactured by Kyoto Electronics Manufacturing Co., Ltd., in the following manner. First, three heat-insulating material samples were stacked to prepare two laminates with a thickness of 18 mm. These laminates were placed one each on the upper and lower sides of the probe so as to sandwich the probe, and a weight of approximately 5 kg, which was not heavy enough to crush the laminates, was placed on top and installed in an electric furnace. Then, the temperature in the electric furnace was raised to 800° C., and after the furnace temperature stabilized, the thermal conductivity was measured.

### (3) Evaluation Criteria

For heat insulating property at room temperature, a thermal conductivity of 0.050 W/m·K or less at room temperature was considered acceptable (indicated by o in Table 1 below), and a thermal conductivity greater than 0.050 W/m·K was considered unacceptable (indicated by x in the same table). For heat insulating property at high temperature, a thermal conductivity of less than 0.30 W/m K at 800° C. was considered acceptable (indicated by o in the same table), and a thermal conductivity of 0.30 W/m·K or more was considered unacceptable (indicated by x in the same table).

### <Evaluation Method for Flexibility and Restorability>

Using the Tensilon universal material testing machine “RTF1350” manufactured by A&D Co., Ltd., a compression test was performed on the manufactured heat-insulating material sample (a square plate measuring 150 mm in length, 150 mm in width, and 6 mm in thickness) by pressing the central portion with a compression terminal having a diameter of 60 mm. The compression test was performed by reciprocating the compression terminal at a speed of 1 mm/minute with an upper limit of compressive stress set at 1.0 MPa, and the section where the compressive stress changed from 0.02 MPa→1.0 MPa→0.02 MPa was defined as one cycle, which was repeated for 3 cycles. Based on the data obtained from the compression test, a stress-compression rate curve was created with the compression rate on the horizontal axis and the compressive stress on the vertical axis. The compression rate on the horizontal axis is the value calculated by the following equation (II).

$$Compression rate ( \% ) = Amount of pressing by the compression terminal ( mm ) after the compressive stress reached 0.01 MPa in the pressing process of the first cycle / Thickness of the heat - insulating material sample ( mm ) when the compressive stress reached 0.01 MPa in the pressing process of the first cycle \times 100 \qquad ( II )$$

### [Flexibility]

In the stress-compression rate curve of the second cycle, the point where the compressive stress was 0.02 MPa at the start of the cycle and the point where the compressive stress was 1.0 MPa were connected by a straight line, and the value obtained by multiplying the slope of the resulting line by 100 was used as the index value for the flexibility of the heat-insulating material sample. That is, the index value for flexibility is the value calculated by the following equation (III).

Flexibility index value=(1.0-0.02)/(a-b)×100 (III)
[a: compression rate (%) when the compressive stress is 1.0 M Pa, b: compression rate (%) when the compressive stress is 0.02 MPa at the start of the cycle]
   In this example, a flexibility index value of 4.0 or less was considered acceptable (indicated by o in Table 1 below), and a value greater than 4.0 was considered unacceptable (indicated by x in the same table).

### [Restorability]

In the stress-compression rate curve of the second cycle, the value obtained by subtracting the compression rate when the compressive stress was 0.02 MPa at the end of the cycle from the compression rate when the compressive stress was 1.0 MPa was used as the index value for the restorability of the heat-insulating material sample. In this example, a restorability index value of 25% or more was considered acceptable (indicated by o in Table 1 below), and a value less than 25% was considered unacceptable (indicated by x in the same table).

### [Evaluation Results of Heat Insulating Property, Flexibility, and Restorability]

Table 1 shows the composition, density, and evaluation results of various properties of the heat-insulating material samples.

TABLE 1

| | | | | | | Comparative | Comparative | Comparative |
|---|---|---|---|---|---|---|---|---|
| | | | Example 1 | Example 2 | Example 3 | Example 1 | Example 2 | Example 3 |
| Material | Organic component | Organic hollow | 160 | 92 | 42 | — | — | — |
| (Unit: g) | | particle | | | | | | |
| | | Organic binder | — | — | — | — | 160 | — |
| | | Organic solid particle | — | — | — | — | — | 160 |
| | Porous structure | Silica aerogel | 282 | | | | | |
| | Infrared ray | Silicon carbide | 58 | | | | | |
| | shielding particle | | | | | | | |
| | Processing aid | Surfactant | 11 | | | | | |
| | Inorganic fiber | Glass fiber | 32 | | | | | |
| | Water | | 685 | 637 | 603 | 574 | 378 | 604 |
| | Content of organic component [mass %] | | 29 | 19 | 10 | 0 | 29 | 29 |
| Density [g/cm³] | | | 0.16 | 0.19 | 0.21 | 0.27 | 0.23 | 0.29 |
| Property | Heat insulating | Thermal conductivity | 0.030 | 0.029 | 0.024 | 0.022 | 0.034 | 0.033 |
| | property | at room temperature | | | | | | |
| | | [W/m · K] | | | | | | |
| | | Evaluation | ◯ | ◯ | ◯ | ◯ | ◯ | ◯ |
| | | Thermal conductivity | 0.18 | 0.20 | 0.16 | 0.15 | 0.30 | 0.38 |
| | | at high temperatures | | | | | | |
| | | [W/m · K] | | | | | | |
| | | Evaluation | ◯ | ◯ | ◯ | ◯ | X | X |
| | Flexibility | Index value | 3.2 | 3.2 | 4.0 | 4.5 | 5.8 | 4.5 |
| | | Evaluation | ◯ | ◯ | ◯ | X | X | X |
| | Restorability | Index value [%] | 33 | 32 | 27 | 23 | 18 | 23 |
| | | Evaluation | ◯ | ◯ | ◯ | X | X | X |

As shown in Table 1, the samples of Examples 1 to 3 containing organic hollow particles in a predetermined proportion were confirmed to excel in heat insulating property both at room temperature, and high temperature. The samples of Examples 1 to 3 were also Confirmed to satisfy both flexibility and restorability. In contrast, according to the samples of Comparative Examples 1 to 3 that (lid not contain organic hollow particles, both flexibility and restorability were inferior. Further, in the sample of Comparative Example 2 in which an organic: binder was compounded., and in the sample of Comparative Example 3 containing organic solid particles instead of organic hollow particles, the heat insulating property at high temperature decreased.

### INDUSTRIAL APPLICABILITY

The heat-insulating material of the disclosure is suitable for vehicle heat-insulating materials, residential heat-insulating materials, electronic device heat-insulating materials, heat-insulating materials for heat retention and cold storage containers, and the like. Among these, it is particularly suitable for heat-insulating materials for battery packs where heat insulating property at high temperature is required, and for heat-insulating mats where cushioning properties are required.

What is claimed is:

1. A heat-insulating material, comprising:
a porous structure in which a plurality of particles are connected to form skeletons and which has pores between the skeletons, infrared ray shielding particles, and organic hollow particles,
wherein the infrared ray shielding particles have a content of 10 mass % or more and 30 mass % or less when a mass of the heat-insulating material is 100 mass %, and
the organic hollow particles have a content of 5 mass % or more and 30 mass % or less when a mass of the heat-insulating material is 100 mass %.

2. The heat-insulating material according to claim 1, wherein the porous structure has an average particle diameter of 1 μm or more and 1000 μm or less.

3. The heat-insulating material according to claim 1, wherein the infrared ray shielding particles have an average particle diameter of 0.3 μm or more and 22 μm or less.

4. The heat-insulating material according to claim 1, wherein the organic hollow particles have an average particle diameter of 1 μm or more and 1000 μm or less.

5. The heat-insulating material according to claim 1, wherein the organic hollow particles have an elastic modulus of 1 MPa or more and 30 MPa or less.

6. The heat-insulating material according to claim 1, wherein the organic hollow particles are made of one or more selected from natural rubber, isoprene rubber, butadiene rubber, styrene-butadiene rubber, ethylene-propylene-diene rubber, chloroprene rubber, urethane rubber, silicone rubber, ethylene-vinyl acetate rubber, epichlorohydrin rubber, acrylic rubber, styrene-based thermoplastic elastomer, vinyl chloride-based thermoplastic elastomer, olefin-based thermoplastic elastomer, polyester, polyacrylonitrile crosslinked body, polymethyl methacrylate crosslinked body, and polybutyl methacrylate crosslinked body.

7. The heat-insulating material according to claim 1, wherein the infrared ray shielding particles have at least one of particles of one type and particles of a mixture of two or more types selected from silicon carbide, kaolinite, montmorillonite, titanium oxide, silicon nitride, mica, alumina, aluminum nitride, boron carbide, iron oxide, magnesium oxide, tin oxide, zinc oxide, tantalum oxide, manganese ferrite, manganese oxide, nickel oxide, nickel, silver oxide, silver, bismuth oxide, carbon black, graphite, titanium, iron titanium oxide, zirconium, zirconia, zirconium silicate, barium titanate, manganese dioxide, chromium oxide, titanium carbide, tungsten carbide, tungsten oxide, niobium oxide, indium tin oxide, and cerium oxide.

8. The heat-insulating material according to claim 1, wherein the porous structure comprises silica aerogel in which a plurality of silica particles are connected to form skeletons.

9. The heat-insulating material according to claim 1, further comprising at least one of a processing aid and an inorganic fiber.

10. The heat-insulating material according to claim 1, wherein the organic hollow particles exist discontinuously between the porous structure and the porous structure.

11. The heat-insulating material according to claim 1, which does not comprise a binder that binds the porous structure, the infrared ray shielding particles, and the organic hollow particles.

12. The heat-insulating material according to claim 1, wherein the organic hollow particles comprise single void-type particles having one void inside.

13. The heat-insulating material according to claim 1, wherein the organic hollow particles comprise multiple void-type particles having multiple voids inside.
